(19) United States
(12) Patent Application Publication
(10) Pub. No.: US 2021/0004849 A1
(43) Pub. Date: Jan. 7, 2021

(54) Systems And Methods To Collect Shopper Data

(71) Applicant: Jim Bark, New York, NY (US)

(72) Inventors: Jim Bark, New York, NY (US); Stefan Rettig, Mississauga (CA)

(21) Appl. No.: 16/978,341

(22) PCT Filed: Mar. 6, 2019
(86) PCT No.: PCT/US2019/020943

§ 371 Date: Sep. 4, 2020

Related U.S. Application Data
(60) Provisional application No. 62/639,206, filed on Mar. 6, 2018.

(51) Int. Cl. G06Q 30/02; G06Q 30/06

(52) U.S. Cl. CPC G06Q 30/0209; G06Q 30/0627; G06Q 30/0212; G06Q 20/206; G06Q 30/0236; G06Q 30/0214; G06Q 30/0224

(57) ABSTRACT

Methods and systems for collecting shopper data are disclosed. A personal electronic computing device (“PECD”) carried by a shopper may be used to communicate with a vendor electronic computing device (“VECD”). A microprocessor of the PECD may execute instructions of a software application in order to facilitate providing the VECD with an indication that the shopper is interested in a particular product. The shopper may be provided with an opportunity to play a game-of-chance. If playing the game-of-chance results in an outcome to the shopper that is favorable, then the shopper may be provided with a benefit. The benefit may be related to the product, such as a discount on the price of the product.

### CROSS-REFERENCE TO RELATED APPLICATION

This application claims the benefit of priority to U.S. provisional patent application Ser. No. 62/639,206, filed on Mar. 6, 2018.

### FIELD OF THE INVENTION

The present invention relates to gathering information about individuals who shop for goods or services (herein, “products”).

### BACKGROUND OF THE INVENTION

Traditional retailers operating from a physical store often lack an effective way to gather information about the behavior and preferences of shoppers. Without such information, traditional retailers cannot effectively tailor offers and promotions in a timely manner so as to encourage a particular shopper to purchase a particular product.

These difficulties are likely a factor contributing to traditional retailers losing market-share to on-line retailers. When it comes to data about shoppers, traditional retailers have a disadvantage relative to retailers selling via the Internet (“on-line retailers”). On-line-retailers are able to compile large amounts of data on a shopper-by-shopper basis. In contrast, when traditional retailers collect data, it is not individual shopper data, but rather, aggregated data regarding the collective behavior of shoppers generally. Although some traditional retailers gather data that tracks in-store movement and purchases of individual shoppers, such data is not available in a timely manner and thus cannot be used to influence a shopper while they are making a decision regarding whether to purchase a particular product.

For example, traditional retailers have limited and ineffective ways in which to collect browsing data (e.g. data about the interests and preferences of individual shoppers). Those options that are available to traditional retailers for collecting browsing data are imprecise, intrusive, and/or labor intensive. For example, traditional retailers can collect browsing data by:
a) Tracking shoppers' movements within stores and recording where they pause and for how long. Long pauses may be used as a proxy for a shopper's interest in items residing in that vicinity. However, such information does not identify the particular item that may be of interest to the shopper. At best, tracking the movements of shoppers is an imprecise proxy for browsing data.
b) Scanning shoppers' faces, for example, using cameras covertly installed above shelves, to track the eye movements of shoppers and determine which items catch their attention. However, such systems are generally considered intrusive, and therefore may negatively impact the shopping experience. Such systems may produce data that is inaccurate since some shoppers may try to avoid being accurately detected by such cameras.
c) Having sales clerks follow each shopper as they walk through the store. This method is not only intrusive, it is also labor intensive since it requires the clerks to manually log what each shopper touches, inspects or compares. Given the high cost of labor, such methods are expensive to implement.

The resulting data deficiency of traditional retailers means that traditional retailers are limited to curating shopping experiences for categories of shoppers, rather than individuals. In addition, retailers are unable to dynamically and timely adjust prices to match an individual shopper's price sensitivity. The lack of accurate and timely data results in traditional retailers being at a competitive disadvantage relative to on-line retailers.

In an increasingly hyper-personalized on-line retail environment, traditional retailers need methods and systems that gather and record data about individual shoppers that are not intrusive or labor intensive. In order to do so, traditional retailers need methods and systems that are able to obtain browsing and purchase data inexpensively, and ideally do so not only with the consent the shopper, but also in a way that generates in the shopper a desire to provide such information. By collecting a particular shopper's browsing data, and comparing that to the shopper's purchase data, traditional retailers may be able to better tailor a shopping experience and adjust prices of specific goods or services at the time a shopper is deciding whether to purchase a product.

### SUMMARY OF THE INVENTION

The invention may be embodied as a system for collecting shopper data. Such a system may include:
(a) a personal electronic computing device (“PECD”) to be carried by a shopper, who may be seeking a product. The PECD may have a microprocessor capable of executing instructions of a computer software application that may be installed on the PECD.
(b) a vendor electronic computing device (“VECD”), which may be controlled by a vendor of such products, or an agent of such a vendor. The VECD may have a microprocessor capable of executing instructions to cause the VECD to communicate with the PECD according to the software application.

The instructions of the software application may be executed by the PECD's microprocessor to enable the PECD to:
send from the PECD to the VECD an interest-indication identifying a product;
provide the shopper an opportunity to play a game-of-chance; and
upon obtaining a favorable outcome from playing the game-of-chance, inform the shopper that a benefit related to the product is available.
   The instructions of the software application may enable the PECD to communicate with a point-of-sale system, and cause the benefit to be applied to a purchase of the related product. Information may be sent from the VECD to the PECD via the communications system, and such information may include a price of the product and/or information about features of the product.

A system according to the invention may include a communications system enabling the PECD to send the interest-indication to the VECD. A system according to the invention may include a communications system enabling the VECD to send information to the PECD.

A system according to the invention may include an electronic data storage device in communication with the VECD. The electronic data storage device may have stored thereon information about the shopper. For example, the information stored on the electronic data storage device may include a browsing history of the shopper.

The invention may be embodied as a method of collecting shopper data. Such a method may include:
(a) providing a software application having computer-executable instructions to a microprocessor of a PECD, which may be a personally portable computing device, such as a smartphone or tablet computer;
(b) receiving an interest-indication from the PECD. The interest-indication may identify a product. For example, the interest-indication may include an identifier identifying the product;
(c) providing to the shopper via the PECD a game-of-chance;
(d) obtaining an outcome from the game-of-chance;
(e) providing to the shopper a benefit related to the product in response to the shopper receiving a favorable outcome from playing the game-of-chance. The benefit may be used upon purchasing the product.
   In some embodiments of the invention, the game-of-chance may be provided in response to the shopper being in or within a predetermined distance of a store that is affiliated with an entity that provided the software application.

A method according to the invention may include providing to the PECD a product-indicator, and then deriving at least part of the interest-indication from the product-indicator. The product-indicator may identify the product corresponding to the identifier of the interest-indication. The product-indicator may be a number, such as a universal-product-code. The product-indicator may be a pattern, such as a bar code, a matrix bar code, a sound (audible or nonaudible), a radio-frequency identification (“RFID”) device, or one or more images. Providing the PECD with a product indicator may be accomplished by scanning, imaging, or recording the product-indicator.

The benefit may be a reduction in the price of the product. The benefit may be an incentive or reward related to the product, or to another product offered by the store. The incentive or reward may be used when purchasing the product.

A method according to the invention may include providing information about the product to the shopper via the PECD. The information about the product may include a price of the product.

In response to the shopper receiving an unfavorable outcome from playing the game-of-chance, the shopper may be offered one or more additional opportunities to play a game-of-chance. The additional opportunities to play the game-of-chance may be limited to a predetermined number. For example, the predetermined number may be at least one and may be not more than fifty per visit to a retail store.

A method according to the invention may be carried out so as to track the location of the PECD while the shopper is in a retail store. Such a retail store may be stocked with products for sale, such as a grocery store. Or, the retail store may provide services, such as a restaurant. Herein, we use “shopper” to refer to an individual that is considering the purchase of a product—i.e. a potential purchaser of goods or services. In ordinary parlance, such an individual might be called a “customer”, “consumer” or “patron”.

In response to the shopper receiving an unfavorable outcome from playing the game-of-chance, a method according to the invention may be further carried out by prompting the shopper to select between (a) playing another game-of-chance, and (b) providing a different interest indication.

In an embodiment of the invention, a method may include accumulating information about the shopper's interest in a particular product. This may be accomplished, for example, in response to detecting that the shopper is in or near a retail store (which may be a competitor) that is not affiliated with an entity that provided the software application. The accumulated information may be used to offer a benefit that can be used by the shopper at a store affiliated with the entity that provided the software application.

In an embodiment of the invention, a method may include receiving information about the shopper's price elasticity for the product. The information related to the price elasticity may be derived from whether the benefit resulted in a completed purchase transaction. That is to say, if the shopper is provided a benefit, such as a reduction in the price of a product, but the shopper does not purchase the product, then it may be concluded and recorded in a database that the price at which the shopper will purchase the product is lower than the reduced price. Information about price elasticity may be used to adjust a price of the product depending on information received about the shopper.

Methods according to the invention may be carried out so as to provide a shopper with an opportunity to share a benefit with a limited number of individuals. Herein, references to sharing a benefit mean that the benefit may be duplicated and given from one person to another. In order to share a benefit with such individuals, information about the limited number of individuals may be received and recorded. The number of individuals with whom the shopper is permitted to share may be selected in order to produce an economic scarcity of shares. That is to say that the number of shared benefits may be selected to be relatively small so that there are more individuals with whom the shopper would like to share. Selecting that number may be made as an educated guess, and/or may be based on data possessed by the vendor. By limiting the number of shared benefits, the shopper may be forced to choose from among a larger number of potential individuals. Those individuals that the shopper chooses may be identified as having a close relationship with the shopper. For example, the chosen individuals may be identified as friends of the shopper. Others may be friends of the shopper, but they will not be identified as such in the database, at least with regard to one instance in which the shopper shares a benefit.

In some embodiments of the invention, an opportunity to share a benefit may be provided only after the product is purchased by the shopper that won the game-of-chance.

Some embodiments of the invention may prompt individuals with whom the shopper shared to further share the benefit, even though those individuals did not play a game-of-chance corresponding to the benefit. Such an opportunity to further share a benefit may be limited to those that use the benefit to purchase the corresponding product.

In embodiments of the invention in which sharing of a benefit is permitted, information identifying who shares with whom may be stored and used to construct a network map identifying relationships between individuals having close relationships and similar interests.

In some embodiments of the invention, the game-of-chance may be provided in response to the shopper being in or within a predetermined distance of a store that is not affiliated with an entity that provided the software application. In such embodiments of the invention, a favorable outcome from playing the game-of-chance may result in a benefit that can be used at a store affiliated with the entity that provided the software application.

A software application may be associated with two or more vendors. A benefit arising from use of the software application may be associated with a store affiliated with at least one of the two or more vendors. In some of these embodiments of the invention, the game-of-chance may be provided in response to the shopper being in or within a predetermined distance of a store affiliated with one of the two or more vendors.

The invention may be embodied as a system that has:
(a) a PECD carried by a shopper of a product, the PECD having a microprocessor capable of executing instructions of a computer software application installed on the PECD; and
(b) a VECD in communication with the PECD via the software application;
wherein the software application enables the PECD:
   to send from the PECD to the VECD an interest-indication identifying a product;
   to provide the shopper an opportunity to play a game-of-chance;
   upon obtaining a favorable outcome from playing the game-of-chance, to inform the shopper that a benefit related to the product is available to the shopper; and
   to communicate with the vendor's point of sale system in order to process the benefit related to the product at the completion of the transaction.
      The benefit may be used upon purchasing the product. Such a system may have a communications system enabling the PECD to send/receive information to/from the VECD. Such a system may have a communications system enabling the VECD to send information to the PECD. Associated with the VECD may be an electronic data storage device having stored thereon information about the shopper.

Other methods that are in keeping with the invention may be embodied as a computer-implemented method of identifying close relationships between human beings. Such methods may:
provide a software application having computer-executable instructions to a microprocessor of a PECD to be carried by a shopper of a product;
receive an interest-indication from the PECD, the interest-indication identifying the product;
provide the shopper with a benefit related to the product (such a benefit may be used upon purchasing the product);
prompt the shopper to share the benefit with an individual of the shopper's choosing;
in response to the shopper sharing the benefit, a relationship-record may be generated in a computer-searchable electronic database, and such a relationship-record may include a shopper-indicator identifying the shopper, and an identity-indicator identifying the individual to indicate that a relationship exists between the shopper and the individual;
provide an additional benefit; and
in response to one or more additional benefits being shared between the shopper and the individual, a flag may be associated with the relationship-record to indicate that the relationship between the shopper and the individual is a close relationship.

The relationship may be flagged as a close relationship in response to the shopper sharing the additional benefit with the individual. However, it may be that a close relationship is identified and then flagged in other ways. For example, the relationship between the shopper and the individual may be identified (and then flagged in the database) as a close relationship in response to the individual sharing the additional benefit with the shopper. Or, a close relationship between the shopper and the individual may be identified (and then flagged in the database) in response to benefits shared between the individual and the shopper if those benefits correspond to unrelated products—i.e. different types of products, products in different categories, and/or products that are not commonly used or purchased together.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a flow diagram depicting a method that is in keeping with the invention;

FIG. 2, which is a schematic of a system that is in keeping with the invention;

FIG. 3, which is a flow diagram corresponding to a method that is in keeping with the invention; and

FIG. 4, which is another flow diagram corresponding to a method that is in keeping with the invention.

### FURTHER DESCRIPTION OF THE INVENTION

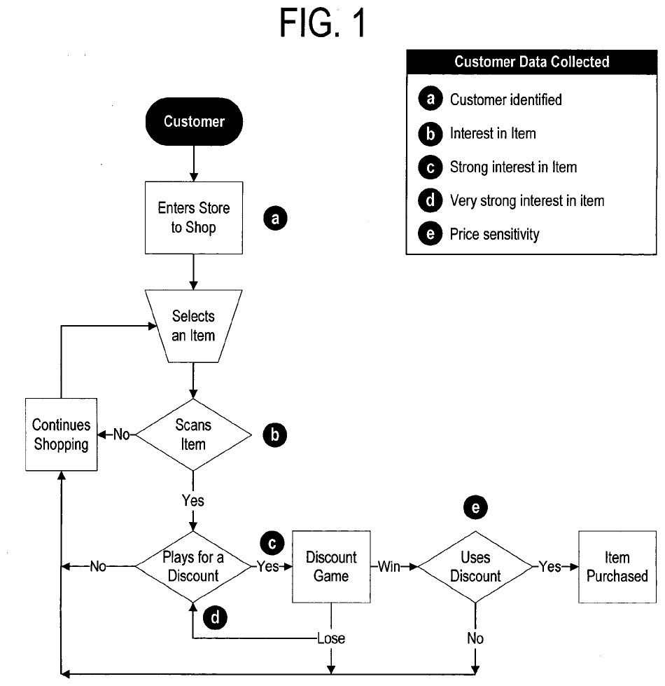

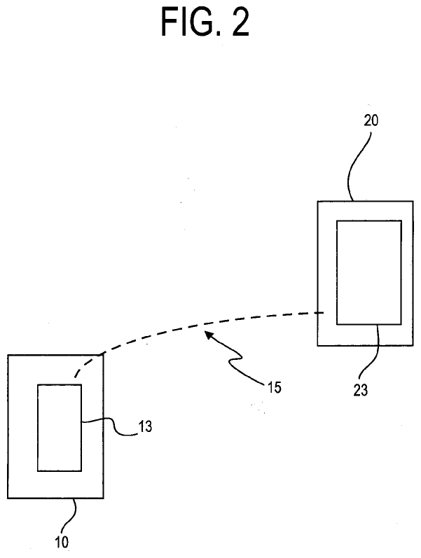

Having provided a general overview of the invention, additional information is provided about particular embodiments of the invention. The invention may be embodied as a method or system to assist a traditional retailer (herein a “vendor”) operating from a physical store (as opposed to an on-line retailer) that shoppers physically visit in order to evaluate whether to purchase a product. Such assistance may take the form of information about a shopper, and that information may be descriptive of, for example, the shopper's browsing activities and/or price sensitivity. FIG. 1 is a flow diagram depicting generally steps of a method that is in keeping with the invention. FIG. 2 is a schematic generally depicting a system that is in keeping with the invention.

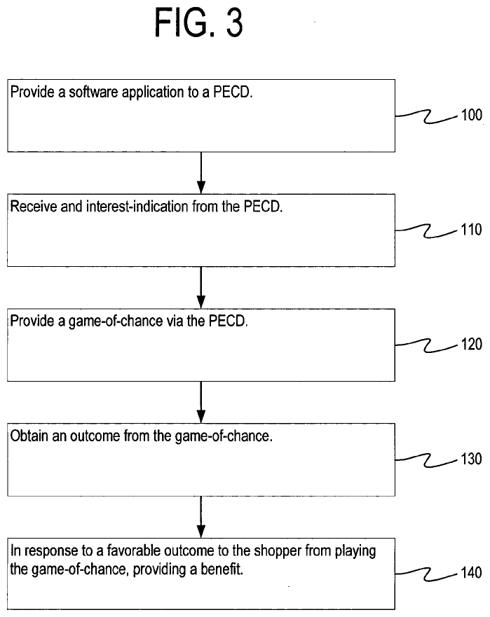

With reference to FIGS. 2 and 3, it will be noted that a PECD 10, such as a smartphone or computer tablet, may be used as an interface between the shopper and the vendor. The PECD may have a receiver and a transmitter that may be used to receive and transmit information via a communications link 15. The PECD 10 may have a software application running thereon so as to enable the shopper in or near the “brick-and-mortar” store of a vendor to identify products that are of interest, and play a game, which may be a game-of-chance, for benefits pertaining to those selected products. The game may have randomized outcomes, or outcomes that appear to be randomized.

The software application includes instructions executable by a microprocessor 13 of the PECD 10 that enables the PECD 10 to create an interest-indication, which may be accomplished by scanning a product's price tag, barcode or QR code, and then sending the interest-indication via a communications link 15 to the VECD 20. The VECD 20 may be a computer having a microprocessor 23 executing instructions of a software program. The VECD 20 may include a receiver and a transmitter for communicating with the PECD 10.

Alternatively, creating an interest-indication may be accomplished by using the PECD 10 to record an image (e.g. taking a photo (single image) or a video (multiple images) of the product or an identifying tag associated with the product), or recording a sound (audible or non-audible, e.g. a sound of the shopper speaking the name of the product, or which may be emitted in response to pressing a button that causes a transmitter to emit a non-audible sound, for example from a display associated with the product), and then sending the interest-indication to the VECD 20. Also, it may be possible to use an RFID device to provide the PECD 10 with information identifying the desired product, and then by using that information the PECD 10 would create and send the corresponding interest-indication. In response to receiving the interest-indication, the VECD 20 may provide the PECD 10 with pricing and product information and/or offer the shopper an opportunity to play a game-of-chance. If the shopper is offered and accepts an opportunity to play a game-of-chance, and doing so produces an outcome that is favorable to the shopper, the VECD 20 may respond by providing the PECD 10 with an indication that a benefit has been obtained. The benefit may be a reduction in the price of the product. Or, the benefit may be an offer to buy an additional product at a discounted price, or a related product at a discounted price. Or, the benefit could be the awarding of a product, such as a product ancillary to the product that was selected by the shopper. By using the invention, a benefit won by a shopper is less likely to be viewed as an annoyance, unlike push marketing offers, because the shopper selected the product and indicated a desire to play for a benefit, and thus there is a strong probability that the shopper is interested purchasing that item.

Once a benefit is obtained by a shopper, the benefit may be limited to use by that shopper. As such, when purchasing the corresponding product, the shopper may be asked to present the PECD 10 to a sales clerk so that the benefit can be applied to the purchase. In such an embodiment of the invention, once a specific benefit is used, it may be extinguished and no longer usable by that shopper.

If the benefit is a discount on the price of the product, the discount may be any percentage (such as from 1% to (and including) 50%) of the standard price of the product, and may include up to and including a discount of 100%. It is believed that for some products, the discount should be in the range from 2% to 20%. However, for other products, it is believed the discount should be in the range from 2% to 10%. Ultimately, the system and method may be configured to test and identify shoppers that are the most price sensitive, that is to say, those shoppers that can be induced to purchase a product with merely a small discount, such as 5% or less.

The probability of having a favorable outcome from the game-of-chance may be decreased as the size of the discount increases. For example, 5% discounts may account for half of the benefits awarded, 10% discounts may account for one-quarter of the benefits awarded, 15% discounts may account for one-eighth of the benefits awarded, and so on, with a 50% discount accounting for only about 1/250 of the benefits awarded. The range of discounts available to be won may be determined based on the product (some products may have higher possible discounts than others), the popularity of the product, the scarcity of the product, the price of the product, the lifecycle of the product, and/or the seasonality of the product. The probability of winning a benefit may be different for each shopper, depending on his/her browsing activity on a particular visit to a store, purchase history, price sensitivity, and/or brand loyalty.

Consequently, via the PECD 10 enabled with the software application, a vendor may learn more information about a particular shopper than was previously possible. By giving shoppers the ability to choose which products will be associated with a game-of-chance, and by associating that game with a potential benefit related to the shopping endeavor, and making that potential benefit available after that game produces a favorable outcome, vendors may be able to obtain information about shoppers, and that information can be used to influence shoppers to more frequently visit a particular store and/or influence shoppers to purchase products more often.

A system and method according to the invention may be configured to offer a shopper a limited number of opportunities to play a game-of-chance. For example, the shopper may be provided with ten such opportunities per visit to a store. The number of opportunities may be predetermined and may be, for example, between one and fifty. If the limited number of opportunities are provided, the shopper may be informed of the number of opportunities in advance so that the shopper is forced to use such opportunities only on products for which the shopper has a heightened interest. The shopper may be allowed to choose the products for which a game-of-chance will be played. As such, the shopper may play all of the games-of-chance with regard to a single product, or the shopper may play the games-of-chance on different products. In this manner, the vendor can better understand which products are important to the shopper and record this information in a database for immediate use, later use, and/or analysis. For example, if a shopper creates and then sends an interest-indication, but does not accept the opportunity to play a game-of-chance, then the vendor may respond by assuming and noting in the electronic database that the shopper does not have a heightened interest in that product. However, if a shopper creates and sends an interest-indication and accepts the opportunity to play a game-of-chance, then the vendor may respond by assuming and noting in the electronic database that the shopper has a heightened interest in that product. And, if the shopper is offered additional opportunities to play a game-of-chance with regard to a particular product and repeatedly accepts the additional opportunities, then the vendor may respond by assuming (because the shopper knows such opportunities are limited) and noting in the electronic database that the shopper has a very heightened interest in that product. And, if during different visits to the store the shopper accepts opportunities to play a game-of-chance with regard to a particular product, the vendor may respond by assuming and noting in the electronic database that the shopper has a high interest in that product.

The level of interest expressed by the shopper via acceptance (or not) of the game-of-chance opportunities may be used to determine a benefit offered to the shopper. For example, if the shopper demonstrates a low interest in the product, then a larger benefit may be offered to the shopper. Or, if the shopper demonstrates a heightened interest in the product, then a smaller benefit may be offered to the shopper. In this manner, the vendor can tailor the benefit so as to increase the likelihood that the shopper will purchase the product, and so that such a purchase is made at a price that is near the shopper's price point (the price above which the shopper will not purchase, and below which the shopper will purchase).

The number of opportunities to play a game-of-chance may be selected at random, or may be selected based on a set of criteria. If the number of opportunities is selected at random, the shopper may be encouraged to visit a store frequently. If not selected at random, the set of criteria may be designed to select the number of opportunities so that the number is not too large, because having too many opportunities to play a game-of-chance may result in losing the scarcity-value of the games, and thus the ability to gauge the shopper's interest in a particular product may also be lost or diminished. If the number of opportunities is too small, a shopper may lose interest and/or the ability to identify the shopper's interests may be limited to a small number of products.

The number of opportunities may be selected based on a perceived willingness of the shopper to play such games. For example, prior experience with a particular shopper may be used to select the number of games that the shopper will be offered during a particular store visit. For example, if prior experience indicates that a shopper will lose interest in playing after a small number of such opportunities, then the predetermined number of opportunities may be selected to encourage the shopper to play a few more games-of-chance than is normal for that shopper. Then, if that shopper plays those additional games and plays those in attempts to obtain a benefit on just one particular product, the vendor may assume and note in the electronic database that shopper has a very heightened interest in that product. Alternatively, if prior experience indicates that a shopper will play a large number of games-of-chance, then the predetermined number of opportunities may be selected to be less than is normal for that shopper. In this manner, that shopper will be encouraged to play games-of-chance only on those products for which the shopper has a heightened interest. In this manner, a vendor can adjust the number of opportunities to play a game-of-chance depending on the particular shopper's previously demonstrated propensity to play a game-of-chance, and thus the vendor can better assess each shopper's interest in a particular product.

A system and method according to the invention may be configured to offer a shopper at least one benefit in response to the shopper playing all opportunities to play a game-of-chance during a store visit. In this manner, the shopper may be encouraged to return to the store at a later time in order to obtain another benefit, and the vendor may be able to assess each shopper's tolerance for playing games-of-chance.

With the software application activated on the PECD 10, the PECD 10 may be enabled to allow the VECD 20 to receive information about the location of the shopper that is carrying the PECD 10. In this manner, the vendor can better identify the types of products that may interest the shopper, and the length of time that the shopper spends evaluating a particular product or class of products. For example, if the shopper lingers in the baked-goods area of a store, but rarely passes through the area dedicated to laundry detergent, the vendor may learn valuable information about that shopper, which can then be used to tailor opportunities presented via the PECD 10 to that shopper.

By tracking a shopper's visit to a store via the PECD 10, recording the interest-indications provided by the shopper via the PECD 10, and recording the shopper's use of the limited opportunities to play a game-of-chance to try to obtain a benefit, a vendor may create knowledge (and store that knowledge in the electronic database) about that shopper that can be used to assist the shopper, the vendor, or both. In addition, if the shopper obtains a benefit, but does not use the benefit, then the vendor may respond by augmenting in a particular way its knowledge (and store that knowledge in the electronic database) about the shopper. However, if the shopper obtains a benefit and uses that benefit, then the vendor may respond by augmenting in a different way its knowledge (and store that knowledge in the electronic database) about the shopper. For example, the vendor may learn that some types of benefits may be more likely to be used by the shopper to purchase a product than others.

Such data may be used by the vendor to better understand that shopper's price elasticity, and thus better determine the level and type of incentives likely to induce that shopper to purchase a product in the future. In particular, by using one or more of tracking data, browsing data, interest data, and purchasing data corresponding to a particular shopper, a vendor may be better able to provide incentives to a shopper that are likely to be valued by the shopper, and the vendor may have a better chance of making a sale to the purchaser. For example, a benefit obtained from playing a game-of-chance may be tailored to a particular shopper so that particular shopper will find that benefit desirable and thus induce the shopper to purchase a particular product. As a result, vendors would have improved ability to tailor price to particular shoppers, and may also tailor those prices over time in order to take account of changes in the marketplace.

With such information, over time, a vendor may be able to evaluate the value of a customer. For example, the so-called customer lifetime value number (“CLV”) may be determined using the following equation:

$$CLV = GC * ( \frac{r}{1 + d - r} )$$

where “GC” is the gross contribution per customer, “d” is the cost of capital, and “r” is the retention rate. See https://en.wikipedia.org/wiki/Customer_lifetime_value for more detail. Use of the invention may induce customers to make more purchases, thereby increasing GC. In addition, use of a game may provide entertainment to shoppers, and thus enhance the shoppers' in-store experience, and increase customer retention rates. Both of these increases should result in increased growth of the CLV.

The invention may be embodied to provide information beyond a particular shopper's product interests. For example, in an embodiment of the invention, a benefit provided to a shopper may be shared with individuals identified by the shopper. In order to share a benefit, the shopper may be required to disclose to the vendor contact information of those that the shopper wants to share with so that the vendor can send the benefit to those individuals. In some embodiments of the invention, the number of individuals with whom the shopper is permitted to share a benefit may be limited. For example, a shopper may be prompted to share a benefit with one, two, three, four, or five individuals. It can reasonably be assumed that the shopper will share a benefit (especially if the number of shared benefits is limited) with an individual that the shopper believes has an interest in the product corresponding to the benefit. As such, those identified by the shopper to receive a benefit are likely to be candidates for purchasing that product. By identifying those individuals, the vendor may obtain contact information for individuals that are likely to be interested in the product corresponding to the shared benefit. With such knowledge, a vendor may tailor advertisements and/or benefits to those individuals with whom the benefit was shared. Further, the vendor may assume that those particular individuals will purchase the product in response to being offered a similar discount.

Furthermore, it can be reasonably assumed that those individuals that the shopper shares a benefit with are likely to be individuals about which the shopper knows some detail. Therefore, by identifying individuals with whom a benefit should be shared, the shopper is likely identifying individuals who are not merely acquaintances. For example, if a shopper opts to share a benefit corresponding to swimming pool equipment with a particular individual, then it may be assumed and noted in the electronic database that the shopper knows the individual has an interest in swimming pool equipment (and may own a pool). If that same shopper also chooses to share with the same individual a benefit corresponding to dog food, and then another benefit corresponding to child car seats, the vendor may conclude that the shopper knows quite a lot about this individual, and thus may be at least friends. And, if the number of shared benefits and diversity of the corresponding products is large, then the vendor may surmise that the shopper knows more than a normal amount of information about this particular individual, and therefore those two are likely to be close friends. By identifying and distinguishing between a shopper's friends and close friends, the vendor may be able to better assess that shopper's ability to influence certain other people on particular topics of interest.

Unlike many existing social media platforms, the invention has the potential to identify an individual's close friends without asking the individual to do so. And, the invention has the ability to modify the perceived strength of these relationships over time without asking the individual to do so. Thus, the invention can be deployed to identify and quantify relationships as those relationships change with time.

From such information, a vendor may decide that a particular shopper has the ability to influence a large number of individuals on a particular topic. For such influential shoppers, the vendor may be inclined to offer that shopper a large price discount on a newly introduced product, for example an electric tooth brush, hoping that that particular shopper will purchase that product, like that product, and then recommend that product to the shopper's friends. In response to the friends arriving at a store, the vendor may tailor a benefit to those friends based on the perceived ability of the shopper to influence his/her friends to purchase that product. For example, if a friend (not a close friend) of the initial shopper arrives at the store, creates an interest-indication indicating an interest in purchasing an electric tooth brush and sends that interest-indication from his/her PECD 10 to the VECD 20, the vendor may assume that this individual may purchase with only a small benefit, on the assumption that the initial shopper made an influential recommendation. However, if a close friend of the initial shopper arrives at the store, creates an interest indication, and sends that interest-indication for the same electric tooth brush, the vendor may assume that this individual (by virtue of being a close friend, and not merely a friend) may purchase that electric tooth brush with no benefit offered, but the vendor may need to offer a small benefit if that close friend sends an interest-indication identifying a different electric tooth brush.

Finally, if the number of individuals with whom the shopper is permitted to share a benefit is very limited, it may be assumed the shopper will share that benefit with close friends, rather than friends who are not close friends. As such, if the number of shared benefits is very limited, the vendor may conclude, without other evidence, that the shopper and those limited number of individuals are close friends.

In addition, allowing a shopper to share a benefit may create an opportunity for the vendor to require an individual that received the shared benefit to download the software application to their PECD 10. Consequently, the number of individuals reachable via the software application may be made to grow. And, for an individual that newly added the software application to his/her PECD 10, the vendor may make certain assumptions about the new shopper, for example, the vendor may create an initial profile based on information known about the original shopper. The idea being that a newly added shopper may have similar characteristics and/or characteristics to the original shopper, based on the aphorism, “You are who your friends are.”

In some embodiments of the invention, in response to an individual receiving a shared benefit and purchasing the corresponding product, that individual may be prompted to further share the benefit, even if that individual does not “win” a game-of-chance corresponding to that purchased product. Doing so may facilitate the gathering of information that can be used to identify shoppers who are influencers, even if the initial shopper does not directly share a benefit with a particular individual. If such a shared benefit continues to be shared from one individual to another, a chain of individuals may be recognized with regard to that benefit and its related product. By knowing such a chain, a vendor may be able to selectively influence certain individuals on the chain, and thereby more effectively influence all individuals who are part of that chain.

With repeated use of the invention, networks of relationships between individuals may be realized, and the strength of connections between such individuals may be determined using the techniques described above. By doing so, a vendor may be able to identify those particular individuals that are likely to have more influence with regard to particular products.

By identifying such social-bond links and the strength of those links, which may range from strong links (strong influence potential) to weak links (low influence potential), more effective marketing approaches may be accomplished. For example, those individuals with a large number of strong links may be targeted for special promotions or provided with additional information about a particular product, in hopes that such an individual will influence a large number of other individuals. Further, clusters of individuals with similar interests may be identified and targeted with promotions tailored to those individuals.

In some embodiments of the invention, several vendors may effectively share a software application. In such an embodiment of the invention, the software application may be used to provide a shopper with information from one or more vendors. In some embodiments of the invention, the location of the shopper may be identified, and then via that shopper's PECD 10, product information and benefits of nearby participating vendors may be provided. In this manner, multiple vendors can share the costs of developing, maintaining, and operating the software application. Additionally, shoppers need not have multiple software applications or the accompanying icons on their PECDs 10 because one software application will effectively link a shopper with many participating vendors. Furthermore, in response to a shopper being at or in the vicinity of a competitor of one of the participating vendors, the software application may be used to provide information and/or benefits via the PECD 10 in order to lure the shopper away from the competitor. Because such a software application is beneficial to a shopper across multiple participating vendors, shoppers may be more likely to actively use the software application and keep it running on their PECD 10 (perhaps continuously) in the background.

The mechanics of multiple vendors sharing a software application may be as follows. During installation of the software application on a PECD 10, the shopper may be asked to activate location services so that the location of the PECD 10 can be tracked. In response to a shopper entering a particular participating vendor's store, the PECD 10 enabled with the software application may recognize that the shopper is in the store of a participating vendor and then begin to communicate with the VECD 20. The shopper may then begin to receive communications on his/her PECD 10 from that vendor. For example, the PECD 10 may display information about products in that store, and offer games-of-chance related to those products. If the shopper is not in a participating vendor's store, the software application may display a neutral appearance or no appearance at all, or may display messages and offers from any of the participating vendors.

If the shopper's PECD 10 has location tracking turned on, the software application may be used to identify whether a shopper is near a participating vendor's store. The participating vendor may choose to be notified of shoppers in its vicinity along with the shopping history profiles of those shoppers. The participating vendor may use this information to determine whether to make an individually tailored offer to a nearby shopper to entice her/him to visit the participating vendor's store.

The software application may be applied by participating vendors to employ an “offensive” strategy. For example, the software application may be used to recognize whether a shopper is in a competitor's store. A participating vendor can then try to draw the shopper out of the competitor's store and into the participating vendor's store by sending to her/his PECD 10 an incentive offer. The participating vendor may choose to further motivate the shopper by making the incentive offer time sensitive. For example, the PECD 10 of the shopper may display a message saying, “Come to our store for [X] benefit, but this offer expires in one hour, so don't delay!”. In this situation, the participating vendor may have access to the shopper's PECD 10 information stored on the VECD 20, and may therefore be better able to tailor the benefit to this particular shopper.

The software application may be configured to prompt a shopper shopping in a competitor's store to use the PECD 10 to search for product information, which may include a product's price at a participating vendor's store. And, the shopper may play a game-of-chance as part of an effort to obtain a benefit corresponding to a particular product, which may only be used at a participating vendor's store and not at the competitor's store. Participating vendors may choose to adjust benefits to be more generous in response to a shopper trying for a benefit while in a competitor's store, thereby increasing the likelihood that the shopper will leave the competitor's store in favor of the participating vendor's store.

The software application may be configured to cause the PECD 10 to collect browsing data of a shopper in response to that shopper using the software application while in a competitor's store. In such a situation, the participating vendor, and not the competitor, will have access to this browsing data. Thus, the software application can be used by participating vendors to obtain additional information, even if a shopper is not in that vendor's store.

With reference to FIG. 3 and the description above, it will be recognized that the invention may be embodied as a computer-implemented method of collecting shopper data. In one such method, a software application having computer-executable instructions may be provided 100 to a microprocessor of a PECD. The shopper may obtain a product-indicator that identifies a product that interests the shopper, and then the PECD may create an interest-indication that may be sent to the VECD. The interest-indication may be received 110 by the VECD. The shopper's PECD may then be enabled to provide 120 the shopper a game-of-chance. An outcome from the game-of-chance may be obtained 130. In response to the shopper receiving a favorable outcome from playing the game-of-chance, the shopper may be provided 140 with a benefit related to the product. Such a benefit may be used upon purchasing the product.

As noted above, some embodiments of a method that is in keeping with the invention may provide 120 the game-of-chance in response to the shopper being in or within a predetermined distance of a store that is affiliated with an entity that provided the software application.

The product-indicator may be a number, such as a universal-product-code. The product-indicator may be a pattern, such as a bar code or a matrix bar code. The product-indicator may be a sound (audible or nonaudible), such as the voice of the shopper speaking the name of the product into a microphone of the PECD. The product-indicator may be an RFID device. The product-indicator may be one or more images, such as a single image of the product or a video of the product taken by using a camera of the PECD. Providing the PECD with a product indicator may be accomplished by scanning, imaging, or recording the product-indicator.

Using the PECD, the shopper may be provided with information, such as information about the product. The information about the product may include a price of the product.

In some methods that are in keeping with the invention, in response to the shopper receiving an unfavorable outcome from playing the game-of-chance, the shopper may be offered one or more additional opportunities to play a game-of-chance. As noted above, the additional opportunities to play the game-of-chance may be limited to a predetermined number. For example, the predetermined number may be at least one per visit to a retail store, and may be limited to, for example, not more than fifty per visit to a retail store.

If a game-of-chance is played and the outcome to the shopper is not favorable, a method according to the invention may be further carried out by prompting the shopper to select between (a) playing another game-of-chance, and (b) providing a different interest indication.

In an embodiment of the invention, a method may include accumulating information about the shopper's interest in a particular product. This may be accomplished (among other times) when the shopper is in or near a retail store that is not affiliated with an entity that provided the software application. The accumulated information may be used to offer a benefit that can be used by the shopper at a store affiliated with the entity that provided the software application.

Methods according to the invention may be carried out so as to provide a shopper with an opportunity to share a benefit with a limited number of individuals. In order to share a benefit with such individuals, information about the limited number of individuals may be received and recorded. The number of individuals with whom the shopper is permitted to share may be selected in order to produce an economic scarcity of shares. That is to say that the number of shared benefits may be selected to be relatively small so that there are more individuals with whom the shopper would like to share. Selecting that number may be made as an educated guess, and/or may be based on data held by the vendor. By limiting the number of shared benefits, the shopper may be forced to choose from among a larger number of potential individuals. Those individuals that the shopper chooses may be identified as having a close relationship with the shopper, and this may be noted and stored in a database. For example, the chosen individuals may be identified as friends of the shopper. Others may be friends of the shopper, but they may not be identified as such in the database because they were not chosen by the shopper to receive the benefit. In some embodiments of the invention, an opportunity to share a benefit may be provided only after the product is purchased by the shopper that won the game-of-chance.

Some embodiments of the invention may permit additional sharing. For example, those individuals with whom the shopper shared a benefit may be offered an opportunity to share that benefit with someone else. This further sharing of the benefit may be permitted even though those individuals did not play a game-of-chance corresponding to the benefit. Such an opportunity to further share a benefit may be limited to those that use the benefit to purchase the corresponding product. In embodiments of the invention that permit benefit sharing, information identifying who shares with whom may be stored in a database, and used to construct a network map identifying relationships between individuals having close relationships and similar interests.

In some embodiments of a method that is in keeping with the invention, the game-of-chance may be provided 120 in response to the shopper being in or within a predetermined distance of a store that is not affiliated with an entity that provided the software application. In such embodiments of the invention, a favorable outcome from playing the game-of-chance may result in a benefit that can be used at a store affiliated with the entity that provided the software application.

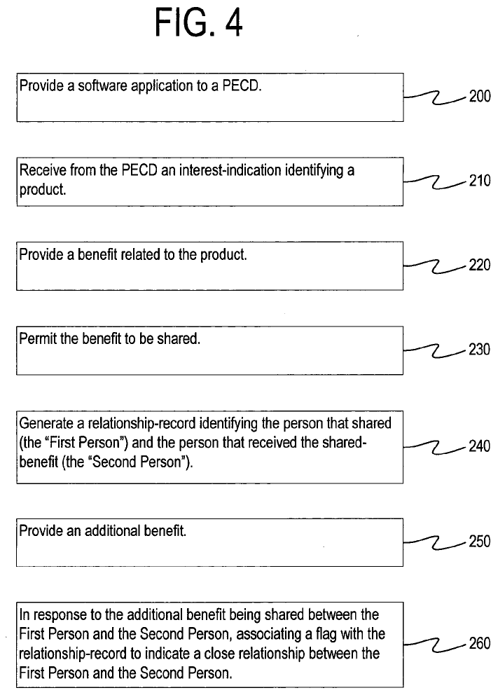

With reference to FIG. 4 and the description above, it will be recognized that the invention may be embodied as a computer-implemented method of identifying a close relationship between human beings. In one such method, a software application having computer-executable instructions may be provided 200 to a microprocessor of a PECD. The software application may be used to create and then send an interest-indication that identifies a product that is of interest to the shopper. After the interest-indication is received 210, for example at the VECD, the shopper may be provided 220 with a benefit related to the product. For example, the benefit may be used upon purchasing the product. The shopper may be prompted 230 to share the benefit with an individual of the shopper's choosing. In response to the shopper sharing the benefit, a relationship-record may be generated 240 in a computer-searchable electronic database. The relationship-record may comprise a shopper-indicator identifying the shopper, and an identity-indicator identifying the individual in order to identify and indicate that a relationship exists between the shopper and the individual.

An additional benefit may be provided 250, and in response to the additional benefit being shared between the shopper and the individual, a flag may be associated 260 with the relationship-record in order to indicate the relationship between the shopper and the individual is a close relationship.

The relationship may be flagged as a close relationship in response to the shopper sharing the additional benefit with the individual. However, it may be that a close relationship is identified in other ways. For example, the relationship between the shopper and the individual may be identified (and then flagged in the database) as a close relationship in response to the individual sharing the additional benefit with the shopper. Or, a close relationship between the shopper and the individual may be identified (and then flagged in the database) in response to benefits shared between the individual and the shopper if those benefits correspond to unrelated products, products in multiple categories, or products that are not normally used or purchased with each other.

It will now be recognized that the invention may be used to provide a shopper with the opportunity to play a game in order to win a benefit, such as a discount or other incentive, corresponding to a product that the shopper chooses. Consequently, shopping-behavior data may be collected, which may include preferences, browsing data, and price sensitivity data.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A system for collecting shopper data, comprising:
a personal electronic computing device (“PECD”) to be carried by a shopper of a product, the PECD having a microprocessor capable of executing instructions of a computer software application installed on the PECD;
a vendor electronic computing device (“VECD”) having a microprocessor capable of executing instructions to cause the VECD to communicate with the PECD via the software application;
wherein execution of the software application instructions enable the PECD to:
send from the PECD to the VECD an interest-indication identifying a product;
provide the shopper with a predetermined limited number of opportunities to play a game-of-chance; and
upon obtaining a favorable outcome from playing the game-of-chance, inform the shopper that a benefit related to the product is available.

2. The system of claim 1, wherein execution of the software application instructions by the PECD's microprocessor enables the PECD to communicate with a point-of-sale system to cause the benefit to be applied to a purchase of the related product.

3. The system of claim 1 further comprising a communications system enabling the PECD to send the interest-indication to the VECD.

4. The system of claim 1, further comprising a communications system enabling the VECD to send information to the PECD.

5. The system of claim 4, wherein the information sent from the VECD to the PECD includes a price of the product.

6. The system of claim 1, further comprising an electronic data storage device in communication with the VECD, the electronic data storage device having stored thereon information about the shopper.

7. The system of claim 6, wherein the information stored on the electronic data storage device includes a browsing history of the shopper.

8. A computer-implemented method of collecting shopper data, comprising:
providing a software application having computer-executable instructions to a microprocessor of a personal electronic computing device (“PECD”) to be carried by a shopper of a product;
receiving an interest-indication from the PECD, the interest-indication identifying a product;
providing to the shopper via the PECD a predetermined limited number of opportunities to play a game-of-chance;
obtaining an outcome from the game-of-chance;
providing to the shopper a benefit related to the product in response to the shopper receiving a favorable outcome from playing the game-of-chance.

9. The method of claim 8, wherein the PECD is a personally portable computing device.

10. The method of claim 9, wherein the PECD is a smartphone or tablet computer.

11. The method of claim 8, wherein the interest-indication includes an identifier identifying the product.

12. The method of claim 11, further comprising providing to the PECD a product-indicator, the product-indicator identifying the product corresponding to the identifier of the interest-indication.

13. The method of claim 12, wherein the product-indicator is a number.

14. The method of claim 13, wherein the number is a universal-product-code.

15. The method of claim 12, wherein the product-indicator is pattern.

16. The method of claim 15, wherein the pattern is a bar code.

17. The method of claim 15, wherein the pattern is a matrix bar code.

18. The method of claim 15, wherein the pattern is a sound.

19. The method of claim 15, wherein the pattern includes one or more images.

20. The method of claim 12, wherein the product-indicator is provided by an RFID device.

21. The method of claim 12, further comprising scanning, imaging, or recording the product-indicator.

22. The method of claim 8, wherein the benefit is a reduction in price of the product.

23. The method of claim 8, wherein the benefit is an incentive or reward usable upon purchasing the product.

24. The method of claim 8, further comprising providing information about the product to the shopper via the PECD.

25. The method of claim 24, wherein the information about the product includes a price of the product.

26. The method of claim 8, wherein in response to an unfavorable outcome from playing the game-of-chance, the shopper is offered one or more additional opportunities to play the game-of-chance, but the total number of times the game-of-chance played by the shopper during a store visit may not exceed the predetermined limited number of opportunities.

27. The method of claim 8, wherein the predetermined limited number is selected in order to produce an economic scarcity of opportunities to play the game-of-chance.

28. The method of claim 27, wherein the predetermined limited number is at least one and not more than fifty per visit to a retail store.

29. The method of claim 8, further comprising tracking a location of the PECD while the shopper is in a retail store.

30. The method of claim 29, wherein the retail store is stocked with products for sale.

31. The method of claim 29, wherein the retail store is a restaurant.

32. The method of claim 8, further comprising prompting the shopper to select between (a) playing another game-of-chance, and (b) providing a different interest indication.

33. The method of claim 8, further comprising accumulating information about the shopper's interest in a particular product.

34. The method of claim 33, further comprising adjusting a price of the product depending on information received about the shopper.

35. The method of claim 33, wherein accumulating the information about the shopper's interest is accomplished in response to detecting that the shopper is in or near a retail store that is not affiliated with an entity that provided the software application.

36. The method of claim 35, wherein the accumulated information is used to offer benefits usable at a store affiliated with the entity that provided the software application.

37. The method of claim 8, further comprising receiving information about the shopper's price elasticity for the product.

38. The method of claim 37, wherein information describing the price elasticity is derived from whether the benefit resulted in a completed purchase transaction.

39. The method of claim 8, further comprising providing the shopper with an opportunity to share the benefit with an individual.

40. The method of claim 39, further comprising receiving information about the individual.

41. The method of claim 39, wherein the individual with whom the benefit is shared is identified as having a close relationship with the shopper.

42. The method of claim 8, further comprising providing the shopper with an opportunity to share the benefit with a limited number of individuals, wherein the limited number is selected in order to produce an economic scarcity of shares.

43. The method of claim 39, wherein the opportunity to share the benefit is provided only after the product is purchased using the benefit.

44. The method of claim 39, wherein the opportunity to further share the benefit is permitted only after that individual purchases the product using the benefit.

45. The method of claim 39, further comprising storing information identifying how benefits are shared, and constructing a network map identifying relationships between individuals having close relationships or similar interests.

46. The method of claim 8, wherein the game-of-chance is provided in response to the shopper being in or within a predetermined distance of a store affiliated with an entity that provided the software application.

47. The method of claim 8, wherein the game-of-chance is provided in response to the shopper being in or within a predetermined distance of a store that is not affiliated with an entity that provided the software application.

48. The method of claim 47, wherein a favorable outcome from playing the game-of-chance results in a benefit that can be used at a store affiliated with the entity that provided the software application.

49. The method of claim 8, wherein the software application is associated with two or more vendors.

50. The method of claim 49, wherein the benefit is associated with a store affiliated with one of the two or more vendors.

51. The method of claim 49, wherein the game-of-chance is provided in response to the shopper being in or within a predetermined distance of a store affiliated with one of the two or more vendors.

52. A system for collecting shopper data, comprising:
a personal electronic computing device (“PECD”) carried by a shopper of a product, the PECD having a microprocessor capable of executing instructions of a computer software application installed on the PECD;
a vendor electronic computing device (“VECD”) in communication with the PECD via the software application;
wherein the software application enables the PECD:
to send from the PECD to the VECD an interest-indication identifying a product;
to provide the shopper with a predetermined limited number of opportunities to play a game-of-chance;
upon obtaining a favorable outcome from playing the game-of-chance, inform the shopper that a benefit related to the product is available to the shopper;
to communicate with a point of sale system in order to process the benefit related to the product at the completion of the transaction.

53. The system of claim 52, further comprising a communications system enabling the PECD to send information to the VECD.

54. The system of claim 52, further comprising a communications system enabling the VECD to send information to the PECD.

55. The system of claim 52, wherein the VECD has an electronic data storage device, the electronic data storage device having stored thereon information about the shopper.

56. A computer-implemented method of identifying a close relationship between human beings, comprising:
providing a software application having computer-executable instructions to a microprocessor of a personal electronic computing device (“PECD”) to be carried by a shopper of a product;
receiving an interest-indication from the PECD, the interest-indication identifying the product;
providing the shopper with a predetermined limited number of opportunities to play a game-of-chance;
upon obtaining a favorable outcome from playing the game-of-chance, providing the shopper with a benefit related to the product;
prompting the shopper to share the benefit with an individual of the shopper's choosing;
in response to the shopper sharing the benefit, generating in a computer-searchable electronic database a relationship-record comprising a shopper-indicator identifying the shopper, and an identity-indicator identifying the individual to indicate that a relationship exists between the shopper and the individual;
providing an additional benefit; and
in response to the additional benefit being shared between the shopper and the individual, associating with the relationship-record a flag that indicates the relationship is a close relationship.

57. The computer-implemented method of claim 56, wherein the relationship is flagged as a close relationship in response to the shopper sharing the additional benefit with the individual.

58. The computer-implemented method of claim 56, wherein the relationship is flagged as a close relationship in response to the individual sharing the additional benefit with the shopper.

59. The computer-implemented method of claim 56, wherein the relationship is flagged as a close relationship in response to sharing between the shopper and the individual benefits corresponding to unrelated products.

60. The method of claim 42, wherein the opportunity to share the benefit is provided only after the product is purchased using the benefit.

61. The method of claim 42, wherein the opportunity to further share the benefit is permitted only after that individual purchases the product using the benefit.

62. The method of claim 42, further comprising storing information identifying how benefits are shared, and constructing a network map identifying relationships between individuals having close relationships or similar interests.
